(19) United States
(12) Patent Application Publication
(10) Pub. No.: US 2015/0203042 A1
(43) Pub. Date: Jul. 23, 2015

(54) Trike Mid-Step Mount/ Dismount Assist

(71) Applicants: Thomas Jerry Honkanen, Maribel, WI (US); Terrance Larson, Colgate, WI (US)

(72) Inventors: Thomas Jerry Honkanen, Maribel, WI (US); Terrance Larson, Colgate, WI (US)

(21) Appl. No.: 14/161,250

(22) Filed: Jan. 22, 2014

(51) Int. Cl. B60R 3/02; B62K 5/027

(52) U.S. Cl. CPC B60R 3/02; B62K 5/027

(57) ABSTRACT

The Trike Mid-Step is specifically designed to aid in the mount/dismount of trikes. It is a platform with a nonslip surface that is strategically placed to give maximum benefit. As an added bonus, it can be used as an alternative footing position for both the driver and the passenger. The Trike Mid-Step is individually modified for each manufacturer. Specifically, the mounting brackets and square tubing vary slightly from model to model and manufacturer to manufacturer. They are easily installed on the lower frame. This invention is designed exclusively for a motorcycle with 3 wheels, more commonly known as a ‘trike’. It is not intended for use on a two wheeled motorcycle.

### CROSS REFERENCE TO RELATED APPLICATIONS

This non-provisional patent application is directly linked to its provisional patent with an application number of 61/756,734; an attorney docket number of 1snapon69 and the filing date of Jan. 25, 2013.

### STATEMENT REGARDING FEDERALLY SPONSORED RESEARCH OR DEVELOPMENT

Not applicable

### REFERENCE TO SEQUENCE LISTING

Not applicable

### BACKGROUND OF INVENTION

A motorcycle trike is a two wheeled motorcycle converted into a three wheeled motorcycle. This can be accomplished several different ways. For the purpose of this document we will focus on the main two methods. The first is manufactory direct as in the case of the Harley Davidson Tri-Glide® made by the Harley Davidson Motor Company, Milwaukee, Wis. The second method is a conversion. In this case, the builder begins with a two wheeled motorcycle. He removes the factory swing arm 1 which is the main component of the rear suspension of most modern motorcycles. He then installs a manufactured conversion swing arm and body shown in FIGS. 2 and 3. The conversion swing arm typically contains an automotive-style differential rear axle and suspension. Several manufacturers supply ready-made conversion kits, for example Champion Side Cars of Garden Grove, Calif. and Roadsmith Trike of White Bear Lake, Minn. In both cases the result is the same, the motorcycle has one front wheel and two rear wheels as shown in FIG. 4. This is what we will refer to as a “trike” for the remainder of this document. The wheelbase of a trike is typically symmetrical from left to right and both rear wheels are driven.

Trikes are becoming more popular as the baby boomer generation ages. According to our research, there are 72 million baby boomers in the US. Twelve percent (12%) or 5 million of them own a motorcycle. Due to the natural aging process, many of these boomers have faced, or will soon be facing, a decision to buy a trike or give up riding since a two-wheeled motorcycle requires substantial strength and full use of both legs to balance the weight of the machine whenever forward motion stops. The trike is a great solution for stability. With three wheels to balance, there is no strength required to hold the bike in an upright position. However, especially when mobility is an issue, mounting/dismounting can be a challenge.

FIG. 4 depicts a trike equipped with foot rests for the driver 2 and passenger 3. These can be pegs or floorboards. Their intended use is to provide a foot rest while riding the bike. When used for the purpose of mounting/dismounting a trike they are quite inadequate for several reasons. First of all, the majority of the boards are not built fully weight bearing. The brackets are designed to withstand pressure but when used as full weight bearing steps they can break.

The second reason is the positioning of the boards. Let us examine the driver board 2. This board is positioned under the gas tank 4. Using this as a step to assist in mounting/dismounting makes it difficult to maintain your balance. The position is too far forward to stand upright without interference from the handlebars and/or windshield. The rider naturally leans forward to compensate often with an end result of hitting their head on the windshield 5.

Next, let's examine the passenger board 3. The position of this board is inadequate for mounting/dismounting on several levels. The height of this board is approximately 16 inches off the ground in comparison, an average stair riser is 7 inches. This height makes it difficult to use for mounting. When they are used to dismount the trike, the passenger has a step approximately 16 inches to the ground. This can cause slips and falls and could lead to injury.

The passenger board's position under the driver's seat 6 varies slightly from manufacturer to manufacturer. In some cases the driver will use the passenger boards to mount. They will mount the passenger seat and then slide forward. This is quite awkward. They are also positioned near the trike fender 7. This causes difficulty for the passenger's mounting/dismounting. All too often, the end result is the foot of the passenger dragging across the body's fender causing damage to the paint.

So what is the solution for this? Well, as far as the damage to the fenders, many have “solved” it by putting some form of protection on the fenders. The two most common forms of protection are a clear plastic adhesive sheet placed on the fenders or a fender bra 7. Both of these are a band aid. Both provide protection for the fenders but does nothing to address the issue of why the fenders are being damaged.

FIG. 8 depicts the prior art that was developed to address the mount/dismount issue, the installation of weight-bearing running boards 8. The running boards run in between the existing lowers 9 and fenders 10. It is important to note that not all running boards on the market are weight-bearing. With that said, let us examine those that are. Running boards must be positioned under the existing foot pegs or boards to allow use of the foot-operated shifter and brake. This lower position makes it even harder to achieve the clearance needed to swing ones leg over the trike seat.

The problem is so significant that the following complex mounting sequence was established as the preferred method as posted on the TrikeTalk.com discussion forum:

### “To Mount a Trike:

1. Put down the passenger floor boards.
2. From the left side of your trike step on your front floor board or peg with your right foot.
3. Hold on to your left grip with your left hand.
4. Stand up on your right foot and step back with your left foot placing it on the passenger floor board.
5. Place your right hand on the right grip.
6. With the weight on your left foot, lift your right foot up and over the tank/seat.
7. Place your right foot on the right front floor board and take your seat.

### To Dismount:

1. Reverse your process above but the first move is to put your left heal/foot on the passenger floor board.
2. Stand up holding on to both grips.
3. Lift your right foot over the tank/seat and walk off the trike.

### For the Passenger:

1. The Passenger gets on first and off last.
2. Follow the same rules for mounting the trike except the passenger holds on to the sissy bar or tour pack instead of the grips.
3. Passenger places right foot on right passenger floor board and takes a seat. Passenger will adjust for the rider's backrest by stepping over it or laying it forward.
4. Passenger dismounts in a similar fashion and walks off the trike.”
Note that in the instructions both hands must be on the handlebars to stand on the driver's foot rests due to the unbalanced body position.

The Trike Mid-Step of the present invention was designed to address all of the issues mentioned above by providing a step in an ergonomically balanced position at the correct height to allow a simple, easy step-over.

### BRIEF SUMMARY OF THE INVENTION

The Trike Mid-Step is a pair of weight baring platforms that are strategically positioned to give maximum benefit. They are centrally located between the driver's board and the passenger's board. They are aligned with the driver's seat which is the lowest point for putting your foot across.

This strategic location of the step allows one to easily maintain balance during mounting/dismounting while providing a minimum step-over. It also provides the passenger with a staircase of steps to aid in the dismount of the trike. The fender damage is also addressed by providing the passenger a mounting/dismounting position that maintains ample clearance to the body of the trike.

The Trike Mid-Step is specifically designed for each manufacturer and model and can be easily installed.

### BASIC DESCRIPTIONS OF THE SEVERAL VIEWS OF THE DRAWINGS

FIG. 1: Two wheeled motorcycle
1: Swing Arm

FIG. 2: A Champion Side Car trike swing arm and rear assembly

FIG. 3: A Roadsmith Trike body

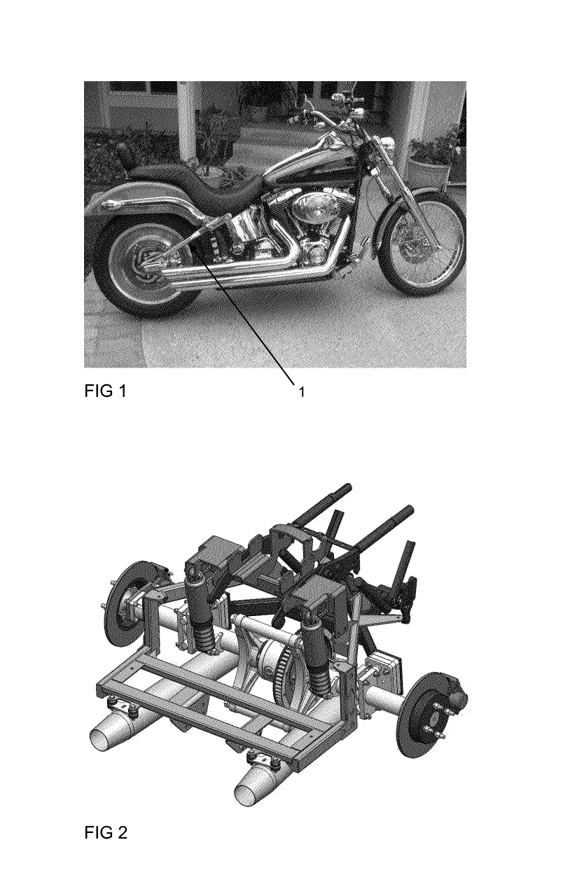

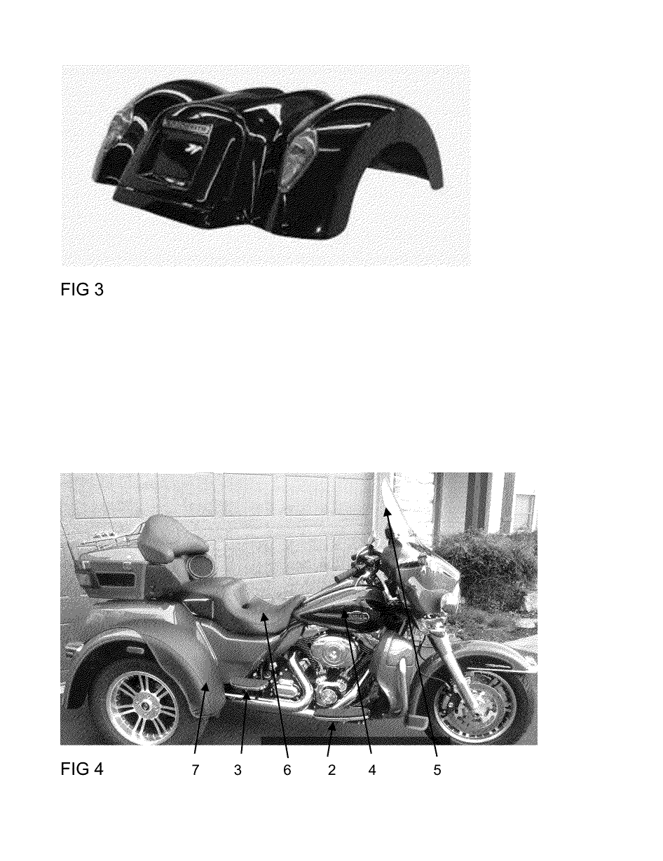

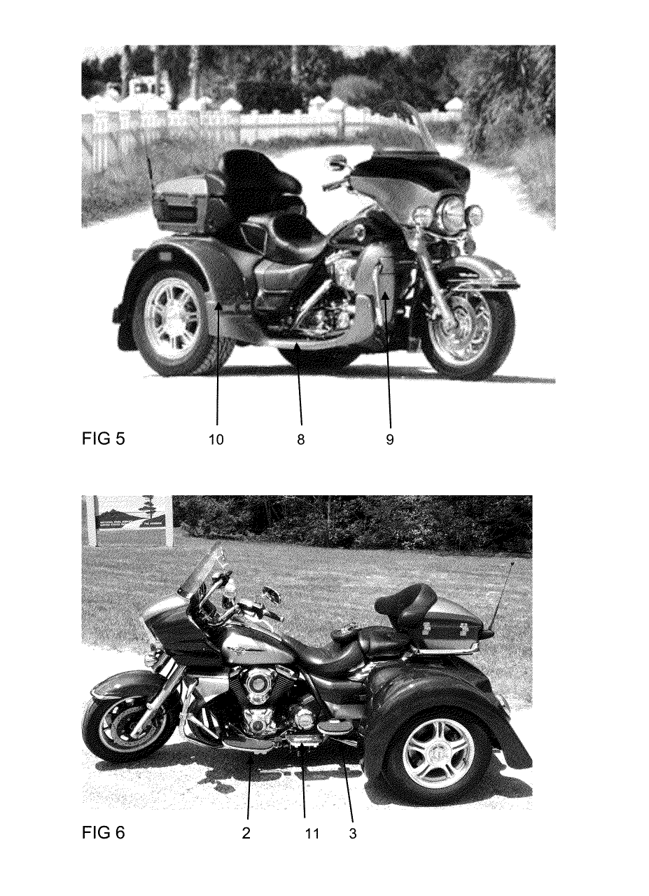

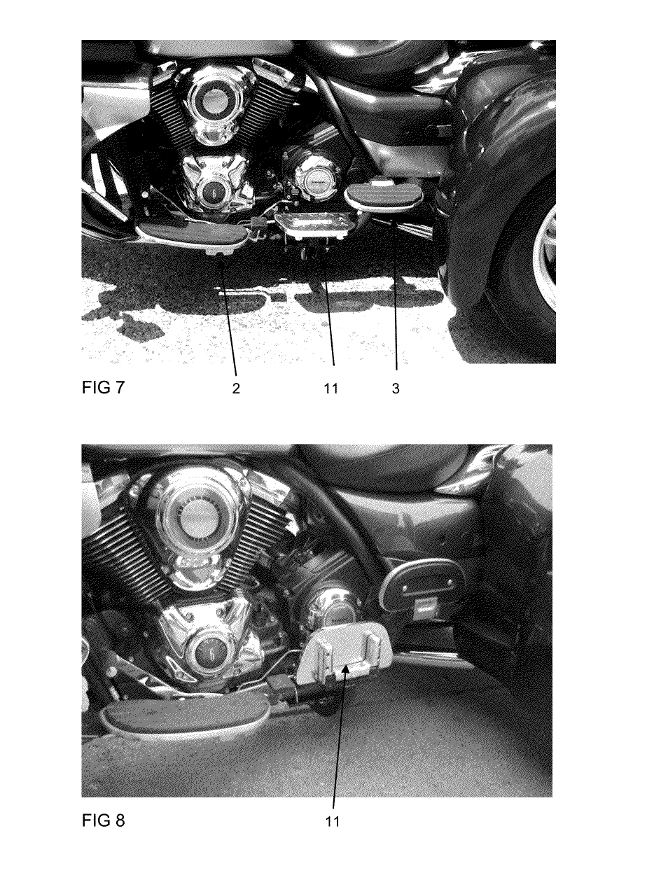

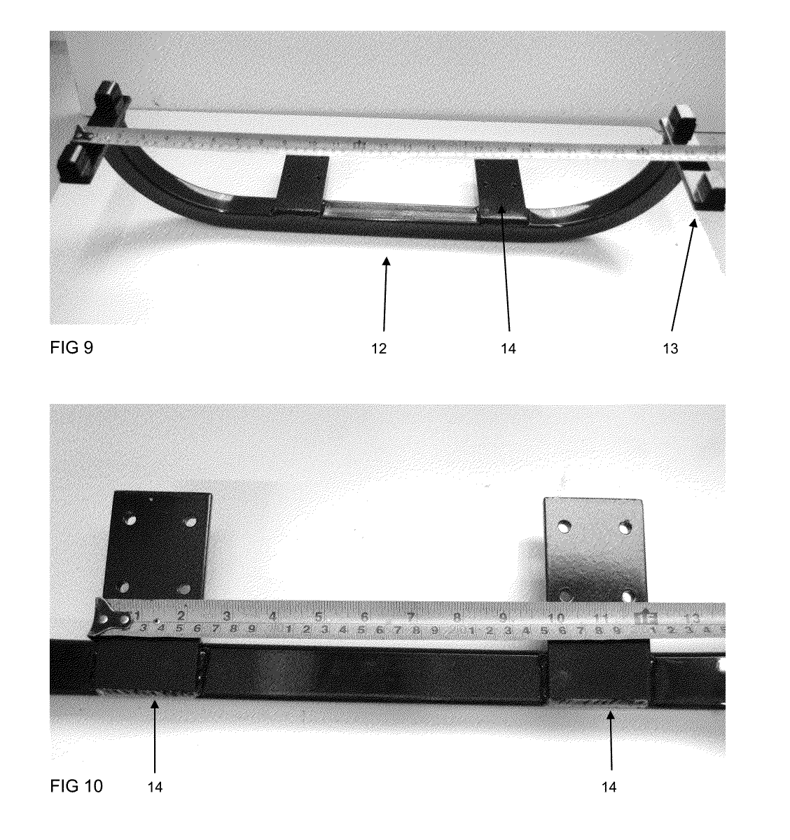

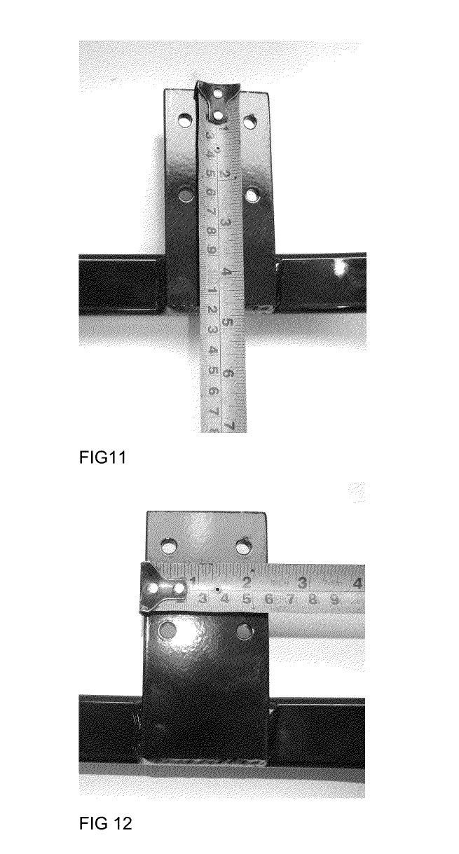

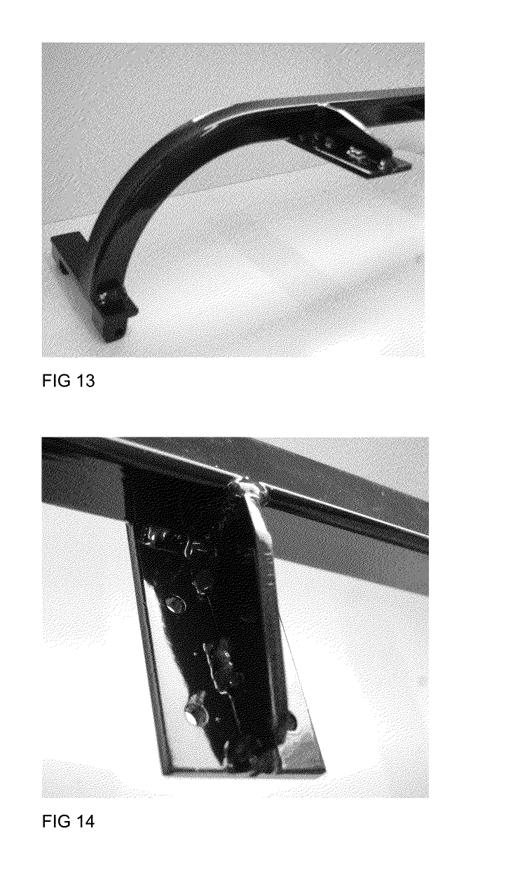

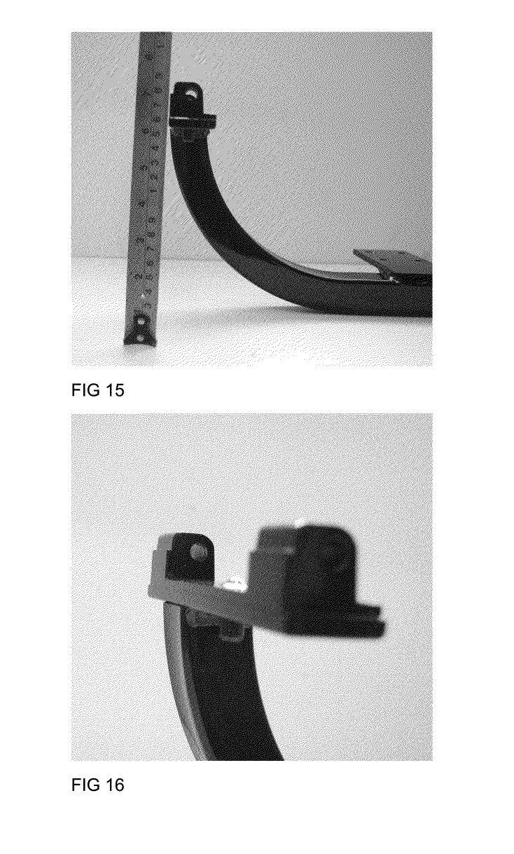

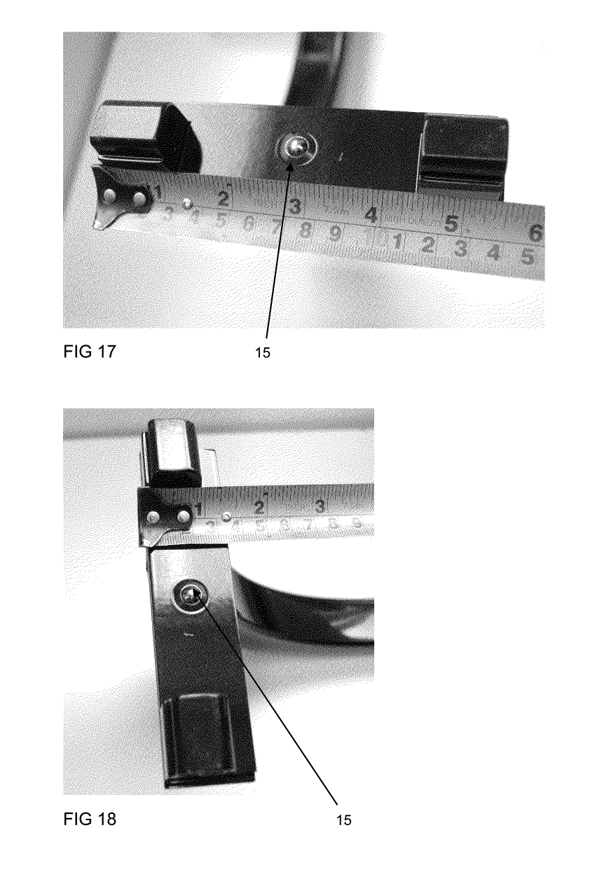

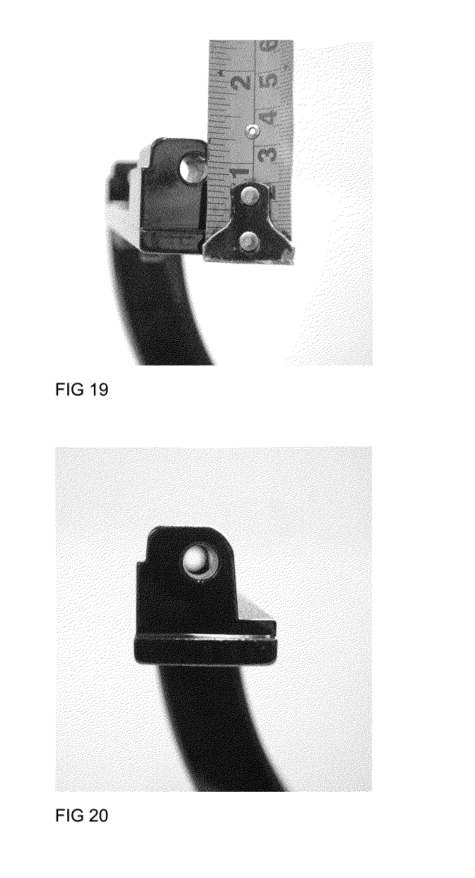

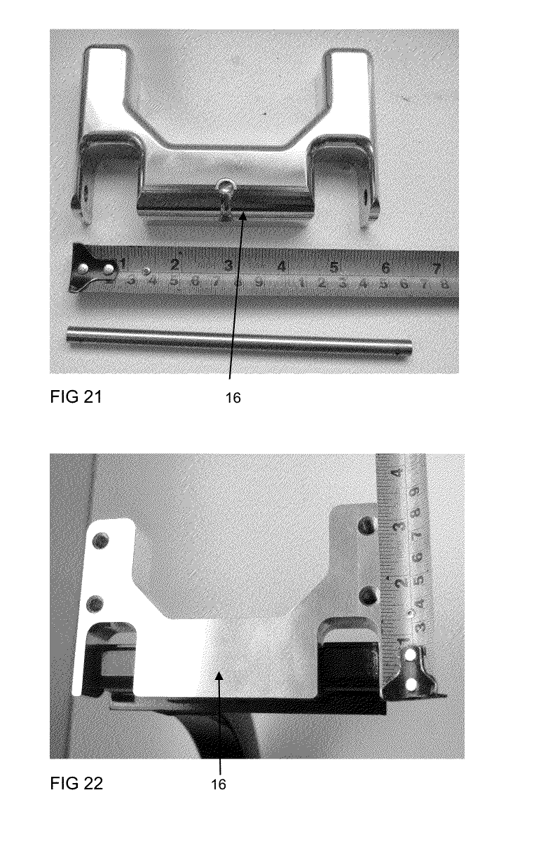

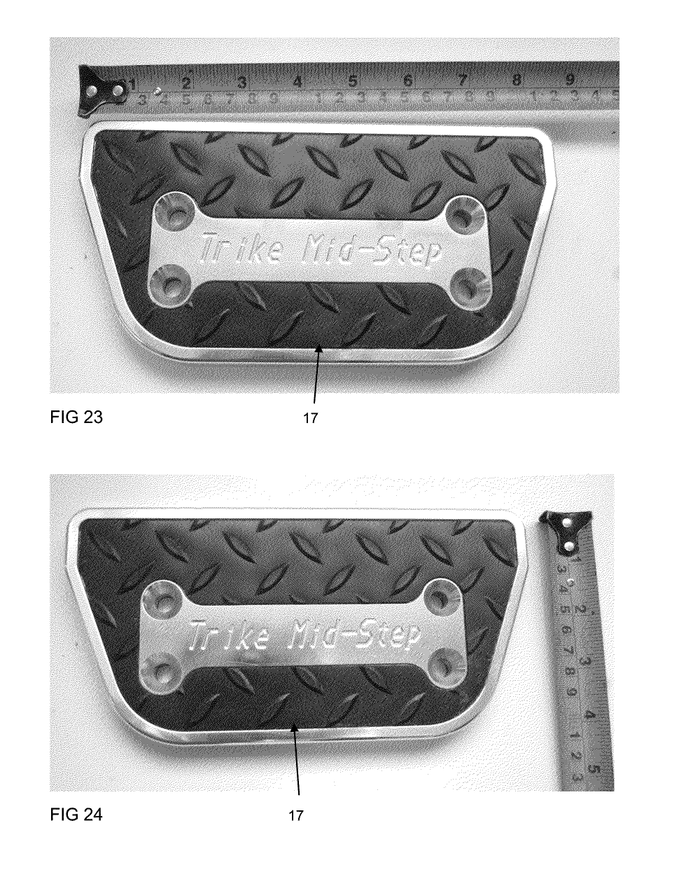

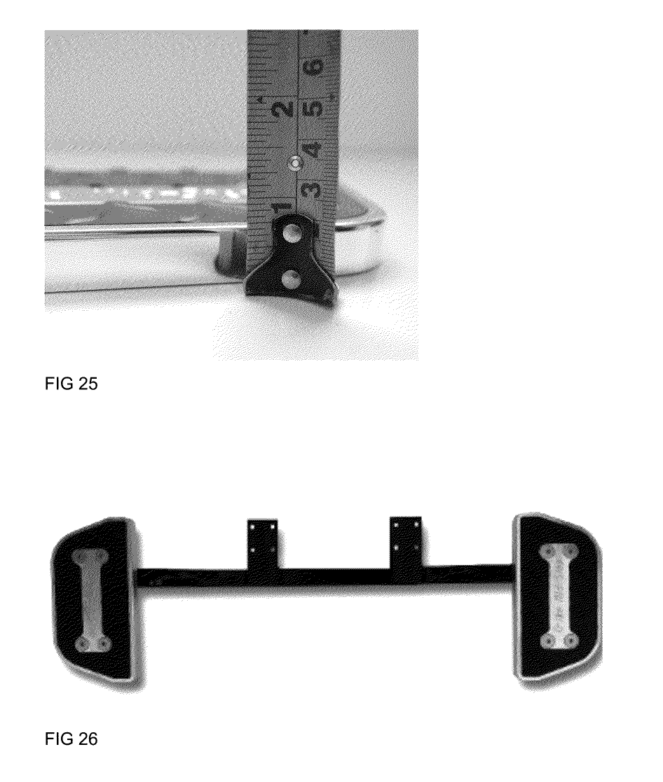

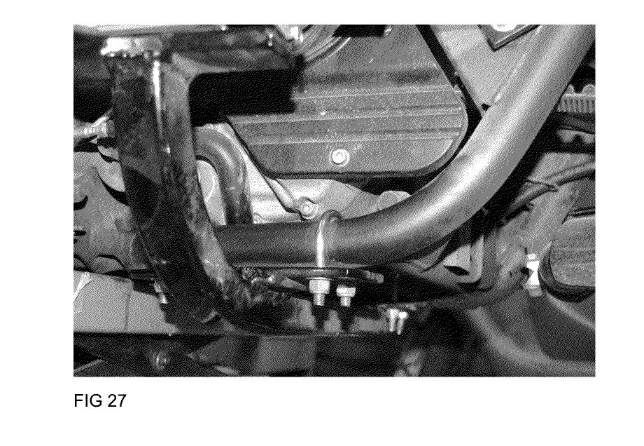

FIG. 4: Trike with driver and passenger floor boards
2: Driver's floor board
3: Passenger's floorboard
4. Gas tank
5: Windshield
6: Driver's seat
7: Fender with fender bra installed

FIG. 5: Trike with running boards
8: Running boards
9: Lowers
10: Fender

FIG. 6: Trike Mid-Step mounted on a 2011 Kawasaki 1700 Vulcan Voyager with a Champion Side Car kit installed by Tom's Cycle and Salvage in Maribel, Wis.
11: Trike Mid-Step

FIG. 7: Close Up of FIG. 6
2: Driver's floor board
3: Passenger's floor board
11: Trike Mid-Step

FIG. 8: Trike Mid-Step in vertical stowed position
11: Trike Mid-Step

FIG. 9: Sub-Frame
12: Sub-frame
13: Hinge mounts
14: Mounting tab

FIG. 10: Distance between mounting tabs
14: Mounting tab

FIG. 11: Mounting tab length

FIG. 12: Mounting tab width

FIG. 13: Under view of sub-frame 12

FIG. 14: Under view close up of mounting tab 14

FIG. 15: Rise of sub-frame 12

FIG. 16: Profile of hinge mount 13

FIG. 17: Length of hinge mount 13
15: Ball plunger

FIG. 18: Width of hinge mount 13
15: Ball plunger

FIG. 19: Rise of hinge mount 13

FIG. 20: Rise close up of hinge mount 13

FIG. 21: Aluminum step base and mounting pin length
16: Aluminum step base

FIG. 22: Aluminum step base width
16: Aluminum step base

FIG. 23: Aluminum Mid-Step length
17: Rubber tread permanently attached within a recessed top surface

FIG. 24: Aluminum Mid-Step width
17. Rubber tread permanently attached within a recessed top surface

FIG. 25: Aluminum Mid-Step thickness

FIG. 26: Complete Trike Mid-Step prior to mounting

FIG. 27: Trike Mid-Step mounted on a 2011 Kawasaki 1700 Vulcan Voyager with a Champion Side Car kit installed by Tom's Cycle and Salvage in Maribel, Wis.

### DETAILED DESCRIPTION OF THE INVENTION

The Trike Mid-Step of the current invention is a set of supplemental steps intended to permit easy mounting and dismounting of a trike. A trike is distinct from a two-wheeled motorcycle in that it has inherent stability at rest to allow the driver and passenger to climb aboard using any installed foot rests or weight-bearing running boards. The application focus of the invention is conventional trikes with a single motorcycle-style front wheel and two automotive style rear wheels. Other variations such as motorcycles equipped with sidecars, reverse trikes, and quads have similar inherent stability and may also benefit from the current invention.

FIGS. 6 and 7 depict Trike Mid-Step 11 positioned between the driver's foot rest 2 and passenger foot rest 3. Mid-Step 11 is aligned with the front of the driver's seat to allow a rider approaching from the left side to step on the Mid-Step with their left leg, then step over the driver's seat with their right leg naturally following a path over the lowest portion of the driver's seat.

FIG. 8 shows mid-step 11 pivoted to a vertical stowed position. This functionality is common to most foot rests and allows freedom of movement when the step is not in use. The step may also function as a foot rest for the driver or passenger, providing variation in riding position for enhanced comfort on long rides. The terms step and foot rest imply slightly different use cases but in terms of part functionality they are interchangeable.

FIGS. 9-20 show Mid-Step sub-frame 12 featuring hinge mounts 13 and frame mounting tabs 14. The position and configuration of tabs 14 will vary depending on which model of trike they are to be installed on. The width and rise of sub-frame 12 may also vary by application. The exemplary sub-frame weldment is constructed of 1″ steel tubing with ⅛″ wall and the tabs and gussets are 3/16″ steel plate. The hinges are machined steel with built-in stops for the deployed and stowed position. Ball plunger 15 visible in FIGS. 17 and 18 engages detents in aluminum step base 16 of FIGS. 21-22 to securely maintain the selected step position.

FIGS. 23-25 depict the details of aluminum mid-step 11 which features a rubber tread 17 permanently attached within a recessed top surface.

Other high-performance materials such as stainless steel, aluminum, magnesium, titanium, or fiber reinforced polymer may also be used for any of the parts providing the assembly will fully bear the weight of a rider.

FIG. 26 depicts the entire mid-step assembly prior to mounting, while FIG. 27 shows the assembly attached to a trike frame using U-bolts. Other clamp types such as handlebar clamps or 2-piece shaft collars may also be used.

1. A platform step positioned between the driver footrest and passenger footrest on a 3-wheel motorcycle.

2. The step of claim 1 with a hinge allowing it to fold upward into a stowed position.

3. The step of claim 1 mounted on a sub-frame attached to the lower frame elements of the 3-wheel motorcycle.

4. The step of claim 1 with a load bearing capacity sufficient to fully support the weight of a rider.

5. A pair of the steps of claim 1 installed on the left and right side of the 3-wheeled motorcycle.

6. A kit which consists of a set of platform steps and mounting hardware with provision for mounting such that the steps are positioned between the driver footrest and passenger footrest on a 3-wheel motorcycle.

7. The kit of claim 6 with hinges allowing the steps to fold upward into a stowed position.

8. The kit of claim 6 including a sub-frame with provision for attachment to the lower frame elements of the 3-wheel motorcycle.

9. The kit of claim 6 with a load bearing capacity as installed sufficient to fully support the weight of a rider.
